(19) United States
(12) Patent Application Publication
(10) Pub. No.: US 2008/0071865 A1
(43) Pub. Date: Mar. 20, 2008

(54) Method, System and Program Product Providing Compact Storage For Electronic Messages

(76) Inventor: Shivnath Dutta, Round Rock, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/532,147

(22) Filed: Sep. 15, 2006

(51) Int. Cl. G06F 15/16

(52) U.S. Cl. 709/206

(57) ABSTRACT

A method of data processing includes selecting an email message, which includes message text, for processing. A determination is then made if the selected email message has a reply email and if the message text of the selected email message is contained in the reply email. In response to determining that the selected email message has a reply email that contains the message text of the reply email, the selected email message is deleted from data storage.

### BACKGROUND OF THE INVENTION

1. Technical Field

The present invention relates generally to data processing systems and in particular to data storage in data processing systems. Still more particularly, the present invention relates to storing electronic messages on a data processing system. Still more particularly, the present invention relates to a method and process for reducing the amount of space required to store electronic mail messages, also called email messages or more simply email, on a data processing system.

2. Description of the Related Art

Data processing systems vary greatly in both size and complexity. However, generally, data processing systems require both hardware and software components to operate. In addition to the basic hardware components, such as the processor and memory, and software components, such as the operating system (OS) and application programs, typical systems also include user interface devices that allow a user to interact with the system, data storage devices that allow a user to store data and/or program code, and a communication adapter that supports data communication between data processing systems.

Data communication involves the transfer of data via one or more data links between one or more sender data processing systems and one or more recipient data processing systems according to a communications protocol. In addition, the data links may incorporate intermediate data processing systems that facilitate the communication. Thus, a data communication network comprises two or more communicating entities (e.g., sender and receiver) interconnected over one or more data links.

A common type of application program that is utilized to support data communication is an email client, such as Lotus Notes or Microsoft Outlook. Email communication and the storage of email messages are widely considered critical to business success. In particular, email communication saves companies money by providing a quick, flexible way to communicate with large groups of people without them having to meet physically. Also, since email is widely employed, email facilitates easy communication between different companies regardless of their geographic location. In addition, email can be used in many ways, e.g., to share ideas, to coordinate activities like meetings, and for general communication. As a result, email has replaced most other forms of written communication in many companies and, as such, needs to be preserved to document the company's activities and to permit subsequent reference.

The ubiquitous use of email dramatically increases the amount of data storage necessary to preserve emails. For example, when a message is sent to several recipients, each recipient receives an individual copy of the email. Thus a single, common message may be stored multiple times in multiple different locations in an enterprise. In addition, when a response is made to a received email, the body of the previous email is frequently included in its entirety within the response to permit easy review of the messages comprising an ongoing discussion. As a result, when several emails are exchanged on a related topic, commonly called an email thread, the length of each subsequent email grows in size. Also, it is common to keep all messages in an email thread, even though the final message, in most cases, contains the entire text of all related, prior emails.

Based on the foregoing, the present invention recognizes that it would be desirable to provide a method, system and program product to reduce the cost associated with storing email messages without losing any of the vital information encapsulated by the email messages. These and other benefits are provided by the invention described herein.

### SUMMARY OF THE INVENTION

Disclosed are a method, system and program product for reducing the amount of data storage space that is required to store electronic mail messages on a data processing system. According to one embodiment, an email message, which includes message text, is selected for processing. A determination is then made if the selected email message has a reply email and if the message text of the selected email message is contained in the reply email. In response to determining that the selected email message has a reply email that contains the message text of the reply email, the selected email message is deleted from data storage.

The above as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further objects, and advantages thereof, will best be understood by reference to the following detailed description of an illustrative embodiment when read in conjunction with the accompanying drawings, wherein:

FIG. 1 depicts a high level block diagram of an exemplary data processing environment in accordance with the present invention; and

FIG. 2 is a high level logical flowchart of the process by which an email that is wholly contained in an email thread can be identified and eliminated in accordance with one embodiment of the invention.

### DETAILED DESCRIPTION OF AN ILLUSTRATIVE EMBODIMENT

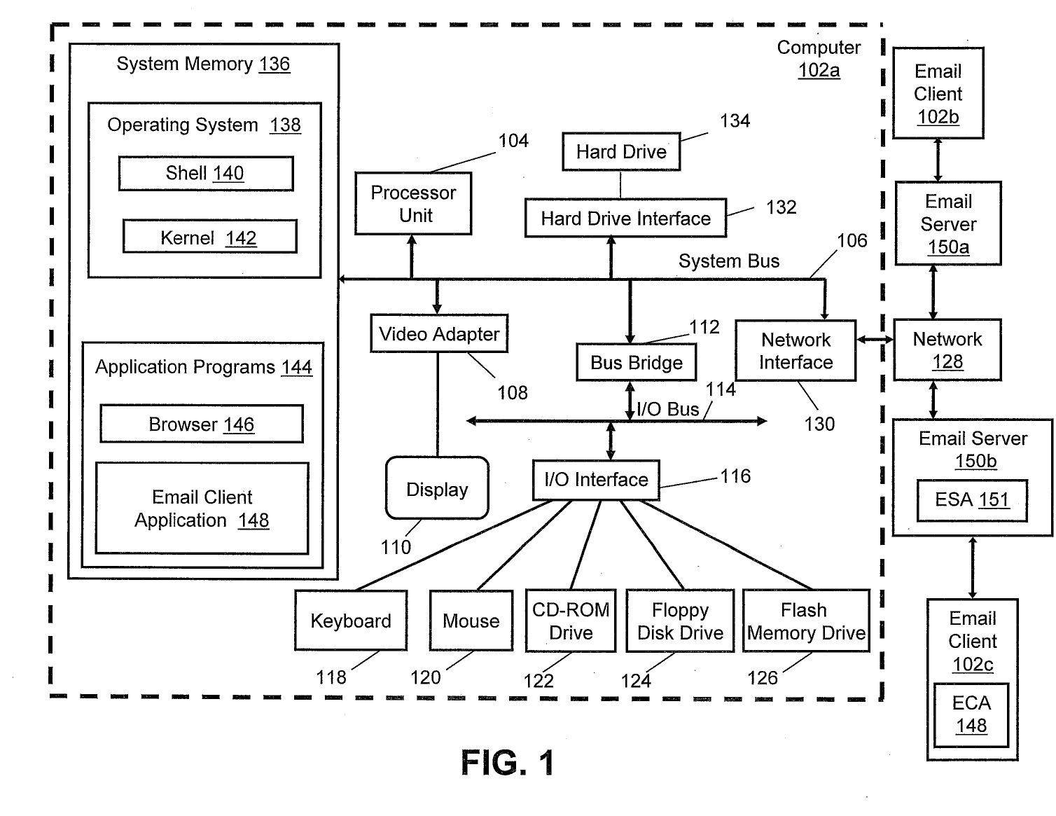

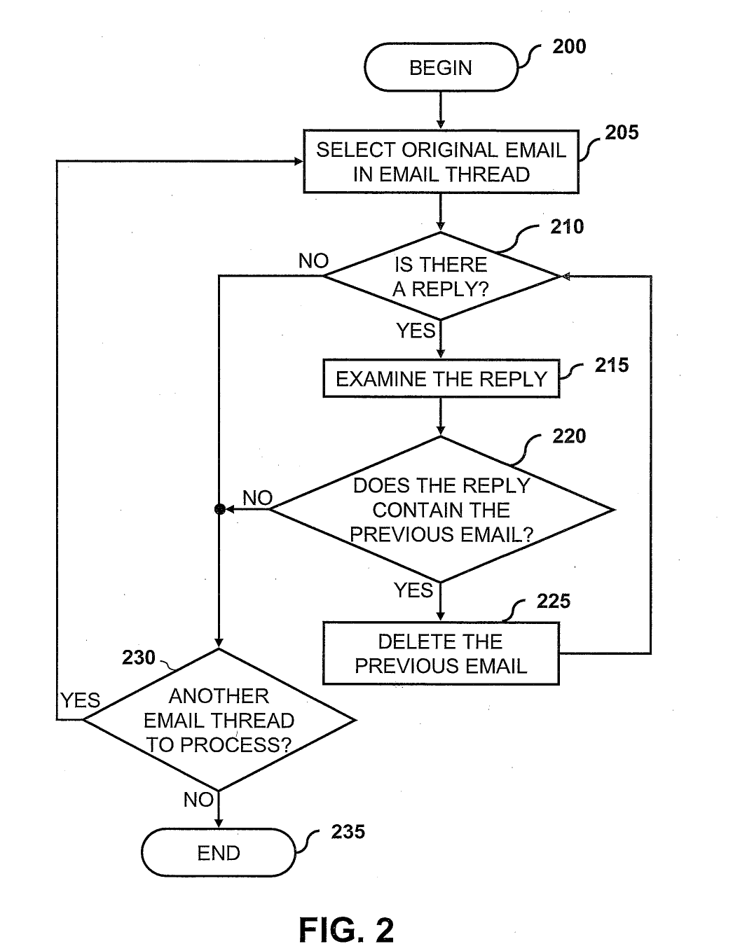

In the following detailed description, like parts are indicated by like numbers. Furthermore, the first digit of each reference numeral generally relates to the figure wherein the primary description of that reference numeral appears. For example, 1xx would have its primary description in relation to FIG. 1, 2xx in relation to FIG. 2, and so forth.

The present invention provides a method and computer program product for reducing the amount of data storage required to store electronic mail messages, also called email messages or more simply email, on a data processing system.

The present invention is preferably executed on a data processing system such as the exemplary data processing system illustrated in FIG. 1 and described below. However, the invention finds applicability in most data processing systems including networking and server data processing systems. The present invention finds applicability on data processing systems irrespective of the operating system (OS), email server software, email client application, or network utilized to support communication, storage and retrieval of email.

With reference now to FIG. 1, there is depicted a block diagram of an exemplary data processing system environment in accordance with the present invention. As depicted, the data processing system environment includes a computer 102a, which may be a desktop, or laptop personal computer, handheld computer, workstation, or other data processing system. Computer 102a includes a processor unit 104 that is coupled to system bus 106. Video adapter 108, which drives/supports display 110, is also coupled to system bus 106. System bus 106 is coupled via bus bridge 112 to Input/Output (I/O) bus 114. I/O interface 116 is coupled to I/O bus 114. I/O interface 116 affords communication with various I/O devices, including keyboard 118, mouse 120, Compact Disk—Read Only Memory (CD-ROM) drive 122, floppy disk drive 124, and flash drive memory 126. The format of the ports connected to I/O interface 116 may be any known to those skilled in the art of computer architecture, including but not limited to Universal Serial Bus (USB) ports.

Computer 102a is able to communicate with a plurality of email servers 150a and 150b via network 128 using network interface 130, which is coupled to system bus 106. Network 128 may be an intranet for an enterprise or may be implemented with or include an external network such as the Internet. Email servers 150a and 150b are provided solely for illustration, and the number of email servers 150 may be more than two. According to the illustrative embodiment, email servers 150a, 150b receive emails transmitted by email clients 102a, 102b, and 102c and distribute emails according to their specified addresses to email clients 102a, 102b and 102c via network 128. Email servers 150 and email clients 102 may both be realized as general-purpose data processing systems like computer 102a or may be alternatively be implemented with special purpose email data processing hardware, as known to those skilled in the art. Email servers 150 execute email server application (ESA) 151 to support email communication by and between email clients 102a-102c, and email clients 102 execute email client application (ECA) 148 to provide email functionality, which in accordance with the present invention includes email messaging.

Hard drive interface 132 is also coupled to system bus 106. Hard drive interface 132 interfaces with hard drive 134. In a preferred embodiment, hard drive 134 populates system memory 136, which is also coupled to system bus 106. System memory is defined as a lowest level of volatile memory in computer 102. This volatile memory may include additional higher levels of volatile memory (not shown), including, but not limited to, cache memory, registers, and buffers. Code that populates system memory 136 includes operating system (OS) 138 and application programs 144.

OS 138 includes shell 140, for providing transparent user access to resources such as application programs 144. Generally, shell 140 (as it is called in UNIX®) is a program that provides an interpreter and an interface between the user and the operating system. As depicted, OS 138 also includes kernel 142, which includes lower levels of functionality for OS 138. Kernel 142 provides essential services required by other parts of OS 138 and application programs 144. The services provided by kernel 142 include memory management, process and task management, disk management, and mouse and keyboard management.

Application programs 144 include browser 146. Browser 146 includes program modules and instructions enabling a World Wide Web (WWW) client (i.e., computer 102) to send and receive network messages via the Internet. Computer 102 may utilize HyperText Transfer Protocol (HTTP) and/or Simple Mail Transport Protocol (SMTP) messaging to enable communication with email server 150a and/or 150b. Application programs 144 in system memory 136 also include an email client application 148.

The hardware elements depicted in computer 102 are not intended to be exhaustive, but rather represent and/or highlight certain components that may be utilized to practice the present invention. For instance, computer 102 may include alternate memory storage devices such as magnetic cassettes, DVDs, Bernoulli cartridges, and the like. These and other variations are intended to be within the spirit and scope of the present invention.

With reference now to FIG. 2, there is illustrated a high level logical flowchart of an exemplary method of processing email messages in accordance with the present invention. In the following description, the depicted method is discussed with reference to an email server application 151. However, those skilled in the art will appreciate that the exemplary method may alternatively or additionally be performed by an email client application 148.

As illustrated, the process begins at block 200, for example, in response to user selection of a “compress storage” option in a menu presented by email server application 151. The command may apply to a particular email storage unit (e.g., an email folder), all emails associated with a particular email account, or all email accounts hosted by an email server 150. Alternatively or additionally, the process may be initiated by email server application 151 automatically in response to detecting that the volume of storage utilized to store email messages for a particular set of one or more email folders or email accounts (possibly including all email accounts managed by email server application 151) has reached a first predetermined threshold. Following block 200, the process proceeds to block 205, which illustrates email server application 151 selecting an email, such as an oldest or original email in a particular email thread, for processing. Email server application 151 then determines at block 210 whether or not a reply to the original email is being stored by its email server 150. If not, the process passes to block 230, which is described below.

If, however, email server application 151 determines at block 210 that email server 150 is storing a reply to the original email, email server application 151 examines the reply email, as indicated at block 215. In examining the reply to the original email, email server application 151 determines whether or not the reply contains the message text of the original email, as depicted at block 220. In a preferred embodiment, the determination at block 220 ensures that the entire message text of the original email, as well as essential header information including at least the sender and date of the email are included within the message text of the reply email. In response to a negative determination at block 220, the process proceeds to block 230, which is described below.

If on the other hand, email server application 151 determines at block 220 that the reply email contains the contents of the original email (e.g., the entire message text and essential header information), email server application 151 deletes the original email from email server 150, as shown at block 225. As indicated by the process returning to block 210, the steps depicted at blocks 210-225 are repeated iteratively until all redundant emails in an email thread have been deleted, resulting in a significantly more compact storage while preserving the essential message text and header information of the email thread. It will be appreciated that the deletion of redundant emails from the storage of email server 150 does not mean that such emails are necessarily removed from all data storage devices in an enterprise, as such email messages may persist on other email clients 102 or email servers 150. Further, the deletion operation depicted at block 225 may be accompanied by a transfer of the email message to some form of archival storage, possibly in a compressed format.

After all redundant emails in an email thread have been deleted, the process passes from either block 210 or block 220 to block 230, which depicts email server application 151 determining whether or not another email thread is to be processed. For example, email server application 151 can make the determination depicted at block 230 by determining whether the volume of storage utilized to store email messages for a particular set of one or more email accounts has fallen below a second predetermined threshold that is less than or equal to the first predetermined threshold. In response to a determination that another email thread is to be processed, the process returns to block 205, which has been described. If email server application 151 determines at block 230 that no further processing is to be performed, the illustrated process terminates at block 235.

As has been described, the present invention provides a method, system and program product that supports compact storage of electronic mail messages on a data processing system.

While the invention has been particularly shown and described with reference to a preferred embodiment, it will be understood by those skilled in the art that various changes in form and detail may be made therein without departing from the spirit and scope of the invention. For example, although an illustrative embodiment of the present invention has been described in the context of a fully functional computer system with installed program code, those skilled in the art will appreciate that the software aspects of an illustrative embodiment of the present invention are capable of being distributed as a program product in a variety of forms, and that an illustrative embodiment of the present invention applies equally regardless of the particular type of media used to actually carry out the distribution. Examples of suitable media include storage media such as thumb drives, floppy disks, hard drives, CDROMs, DVDs, and transmission media such as digital and analog communication links.

What is claimed is:

1. A method of data processing, said method comprising:
selecting an email message for processing, the email message including a message text;
determining if the selected email message has a reply email and if the message text of the selected email message is contained in the reply email; and
in response to determining that the selected email message has a reply email that contains the message text of the reply email, deleting the selected email message from data storage.

2. The method of claim 1, wherein said selecting, determining and deleting steps are performed utilizing an email server application.

3. The method of claim 1, wherein said selecting, determining and deleting steps are performed utilizing an email client application.

4. The method of claim 1, wherein said selecting, determining and deleting steps are performed in response to detecting that an amount of data storage being utilized to store email messages exceeds a first threshold.

5. The method of claim 4, and further comprising repetitively performing the selecting, determining and deleting steps for a plurality of email threads until the amount of data storage being utilized to store email messages falls below a second threshold.

6. The method of claim 1, wherein:
the selected email message includes header information, said header information including a name of a sender and a date;
said determining includes determining if the reply email includes an entirety of said message text and said header information; and
said deleting is performed only if the reply email includes an entirety of said message text and said header information.

7. A program product comprising:
a tangible computer readable medium; and
program code, within said tangible computer readable medium, for performing a method including the following steps:
selecting an email message for processing, the email message including message text;
determining if the selected email message has a reply email and if the message text of the selected email message is contained in the reply email; and
in response to determining that the selected email message has a reply email that contains the message text of the reply email, deleting the selected email message from data storage.

8. The program product of claim 6, wherein said selecting, determining and deleting steps are performed utilizing an email server application.

9. The program product of claim 6, wherein said selecting, determining and deleting steps are performed utilizing an email client application.

10. The program product of claim 6, wherein said method further comprises performing the selecting, determining and deleting steps in response to detecting that an amount of data storage being utilized to store email messages exceeds a first threshold.

11. The program product of claim 9, said method further comprising repetitively performing the selecting, determining and deleting steps for a plurality of email threads until the amount of data storage being utilized to store email messages falls below a second threshold.

12. The program product of claim 7, wherein:
the selected email message includes header information, said header information including a name of a sender and a date;
said determining includes determining if the reply email includes an entirety of said message text and said header information; and
said program code performs said deleting only if the reply email includes an entirety of said message text and said header information.

13. A data processing system, comprising:
a processor unit; and
data storage coupled to the processor unit, said data storage including program code for causing the data processing system to perform a method including the following steps:
selecting an email message for processing, the email message including message text;
determining if the selected email message has a reply email and if the message text of the selected email message is contained in the reply email; and
in response to determining that the selected email message has a reply email that contains the message text of the reply email, deleting the selected email message from data storage.

14. The data processing system of claim 13, wherein said program code comprises an email server application.

15. The data processing system of claim 13, wherein said program code comprises an email client application.

16. The data processing system of claim 13, wherein said method further comprises performing the selecting, determining and deleting steps in response to detecting that an amount of data storage being utilized to store email messages exceeds a first threshold.

17. The data processing system of claim 16, said method further comprising repetitively performing the selecting, determining and deleting steps for a plurality of email threads until the amount of data storage being utilized to store email messages falls below a second threshold.

18. The data processing system of claim 13, wherein:
the selected email message includes header information, said header information including a name of a sender and a date;
said determining includes determining if the reply email includes an entirety of said message text and said header information; and
said program code performs said deleting only if the reply email includes an entirety of said message text and said header information.
